(19) United States
(12) Patent Application Publication
(10) Pub. No.: US 2007/0040448 A1
(43) Pub. Date: Feb. 22, 2007

(54) EXTENSION CABLE WITH AC POWER SOCKETS AND DC POWER SOCKETS

(76) Inventor: Tsung-I Yu, Pan-Chiao City, Taipei County (TW)

Correspondence Address: PAI PATENT & TRADEMARK LAW FIRM, 1001 FOURTH AVENUE, SUITE 3200, SEATTLE, WA, 98154, US

(21) Appl. No.: 11/161,783

(22) Filed: Aug. 16, 2005

(51) Int. Cl. H02J 3/14

(52) U.S. Cl. 307/38

(57) ABSTRACT

Disclosed is an extension cable, which includes an electric plug for city power supply input, an electric outlet assembly, which houses a plurality of AC power sockets and a plurality of DC power sockets, a power cable electrically connected between the electric outlet assembly and the electric plug, and a control circuit, which comprises a transforming circuit, a rectifier circuit, a filter circuit, a voltage stabilizer circuit and an output circuit electrically connected in series between the power cable and the DC power sockets for processing input AC power supply into stabilized DC power supply for output through the DC power sockets.

### BACKGROUND OF THE INVENTION

1. Field of the Invention

The present invention relates to an extension cable and more particularly to such an extension cable that has AC power sockets for AC power output and DC power sockets for DC power output.

2. Description of the Related Art

Various extension cables are commercially available. A conventional extension cable generally comprises an electric plug for city power input, an electric outlet assembly, and a power cable electrically connected between the electric plug and the electric outlet assembly. The electric outlet assembly comprises an electrically insulative housing that houses at least one power socket. A power socket for this purpose has at least two insertion slots including one positive pole insertion slot and one negative pole insertion slot. A power socket may have a grounding slot for receiving the grounding prong of an electric plug. There is also known a four-slot type power socket. City power supply may provide 110V or 220V. An electric outlet assembly for computer may have 5, 6, 8 or 10 power sockets. Following the development and application of multimedia and network technology, a computer may be equipped with many peripheral apparatus that consume DC voltage. For providing the necessary DC power supply from the power sockets of the electric outlet assembly of an extension cable to the various peripheral apparatus of a computer system, many transformers or AC adapters shall be used. It is inconvenient to use an extension cable with the various peripheral apparatus of a computer system through many transformers or AC adapters.

### SUMMARY OF THE INVENTION

The present invention has been accomplished under the circumstances in view. It is the main object of the present invention to provide an extension cable which comprises AC power sockets for AC output and DC power sockets for DC output. It is another object of the present invention to provide an extension cable with AC power sockets and DC power sockets, which has voltage control means for selection of output DC voltage for output through the DC power sockets.

To achieve these and other objects of the present invention, the extension cable comprises an electric plug for city power supply input, an electric outlet assembly, which houses a plurality of AC power sockets and a plurality of DC power sockets, a power cable electrically connected between the electric outlet assembly and the electric plug, and a control circuit, which comprises a transforming circuit, a rectifier circuit, a filter circuit, a voltage stabilizer circuit and an output circuit electrically connected in series between the power cable and the DC power sockets for transforming input AC power supply into stabilized DC power supply for output through the DC power sockets. The control circuit further comprises a protection circuit for overload protection, and a display circuit for power output indication.

### BRIEF DESCRIPTION OF THE DRAWINGS

FIG. 1 is a perspective view of an extension cable according to the present invention.

FIG. 2 is a perspective view of an alternate form of the extension cable according to the present invention.

FIG. 3 is a circuit block diagram of the extension cable according to the present invention.

FIG. 4 is a circuit diagram of the extension cable according to the present invention.

FIG. 5 is an alternate form of the circuit block diagram of the extension cable according to the present invention.

FIG. 6 is an alternate form of the circuit diagram of the extension cable according to the present invention.

### DETAILED DESCRIPTION OF THE PREFERRED EMBODIMENT

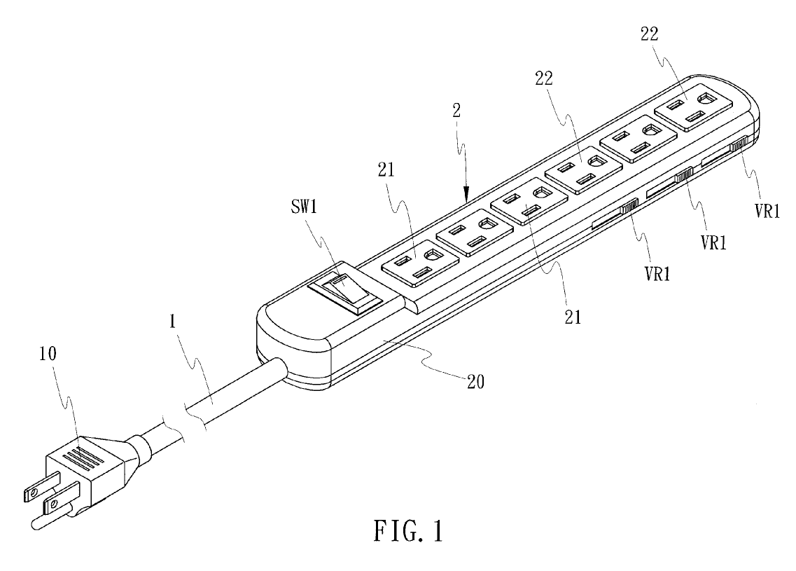

Referring to FIGS. 1˜4, an extension cable in accordance with the present invention is shown comprising an electric plug 10, a power cable 1, and an electric outlet assembly 2. The electric outlet assembly 2 comprises a housing 20, at least one AC power socket 21 and at least one DC power socket 22 mounted in the housing 20 and connected in parallel, and a control circuit electrically connected between the power cable 1 and the DC power sockets 22. The control circuit comprises a transforming circuit 31, a rectifier circuit 32, a (DC) filter circuit 33, a (DC) voltage stabilizer circuit 34, and an output circuit 35. The transforming circuit 31 is electrically connected to the power cable 1 to transform input AC power supply. The rectifier circuit 32 is electrically connected to the output end of the transforming circuit 31 to rectify AC current passing out of the transforming circuit 31 into DC current. The filter circuit 33 is electrically connected to the output end of the rectifier circuit 32 to remove noises from DC current passing out of the rectifier circuit 32, thereby providing a full-wave DC output. The voltage stabilizer circuit 34 is electrically connected to the output end of the filter circuit 33 to stabilize the voltage and current of the full-wave DC output of the filter circuit 33 for output through the output circuit 35.

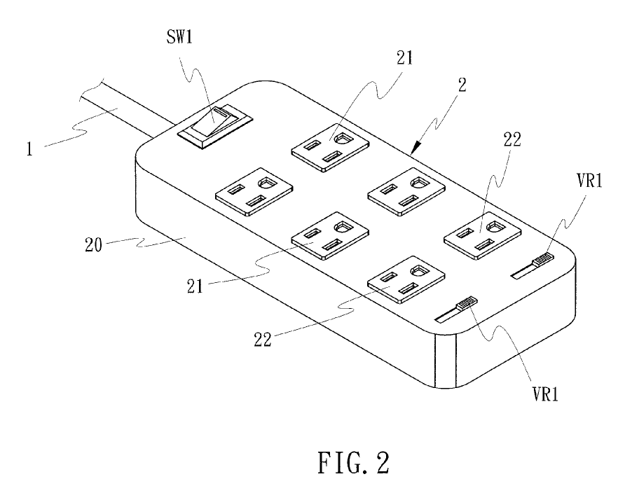

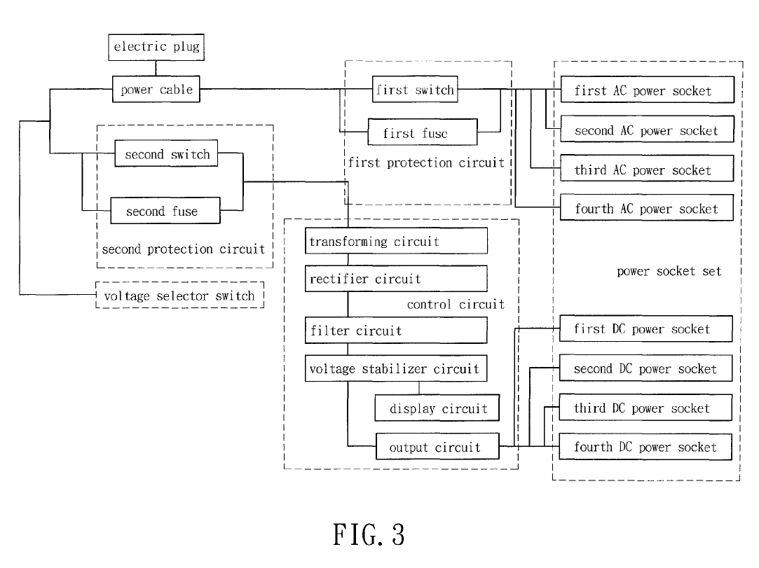

In the embodiment shown in FIG. 1, the electric outlet assembly 2 of the extension cable comprises a row of power sockets including three AC power sockets 21 arranged at the front side and three DC power sockets 22 arranged at the rear side; in the embodiment shown in FIG. 2, the electric outlet assembly 2 of the extension cable comprises two rows of power sockets, each row of power sockets including two AC power sockets 21 at the front side and one DC power socket 22 at the rear side; the circuit block diagram in FIG. 3 shows four DC power sockets 22 and four AC power sockets 21 numbered from the first through the fourth. This is only for the purpose of illustration; other combinations can be easily achieved for the present invention.

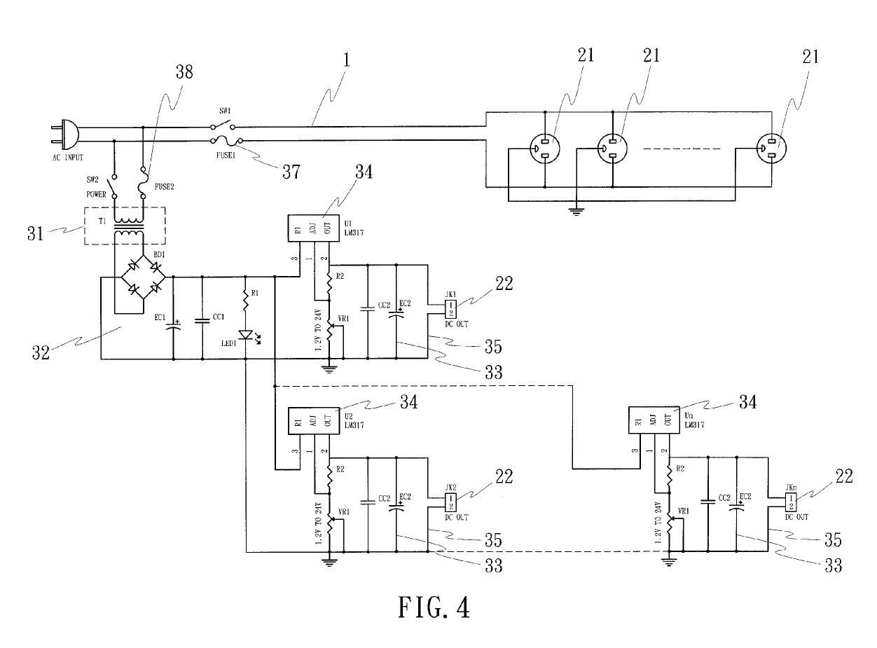

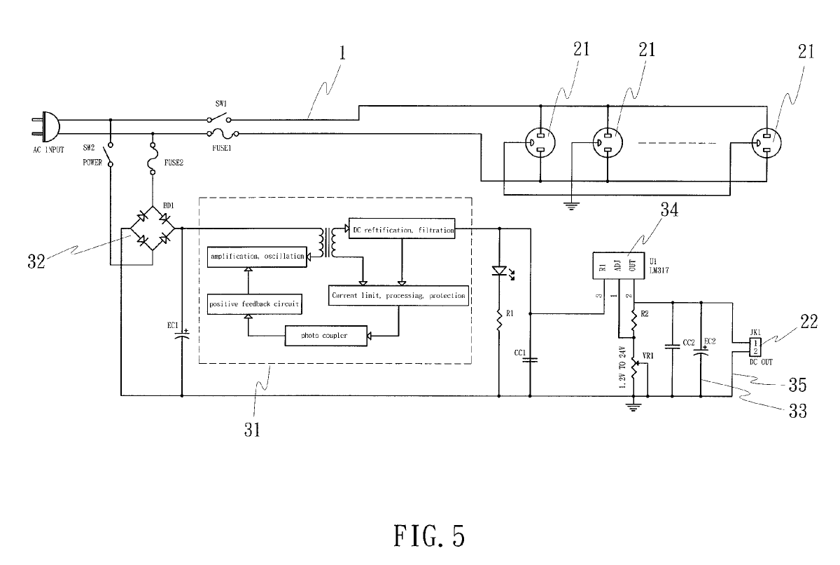

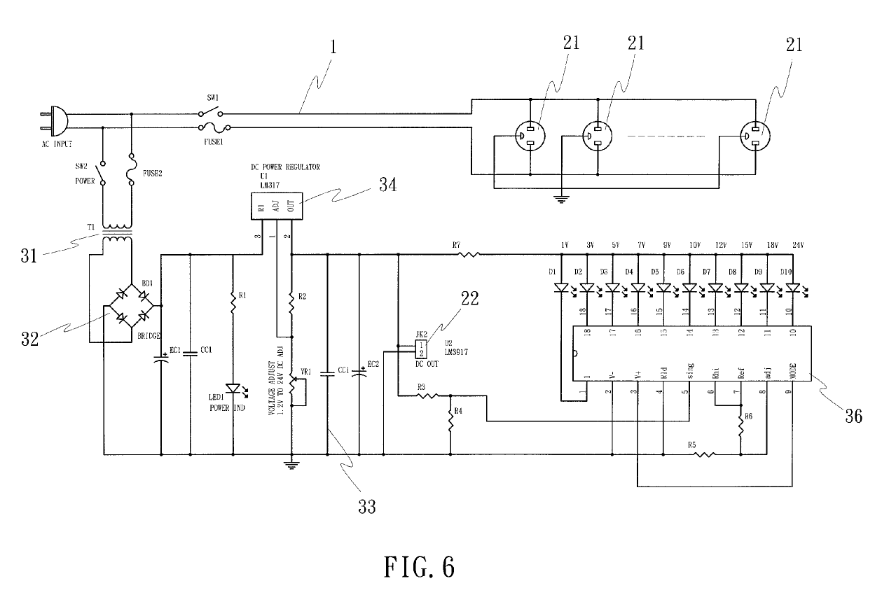

The control circuit further comprises protection circuits 37 and 38 and a display circuit 36 (see FIG. 6). A voltage selector switch may be provided for selecting 110V/220V input city power. The use of a voltage selector switch assures safe operation of the transforming circuit 31. The transforming circuit 31 can be a transformer (see FIG. 4), or an AC adapter (see FIG. 5).

The rectifier circuit 32 is a bridge rectifier comprised of four diodes and adapted to rectify input AC power supply into DC power supply for output. Other measures may be selectively used to rectify input AC power supply into DC power supply.

In FIG. 4, the transforming circuit 31 is a conventional voltage-dropping transformer. The rectifier circuit 32 rectifies input power into the desired DC power out, which is then transmitted to a voltage control, for example, a variable resistor VR1 that controls voltage output ranging from 1.2V-24V. The selected DC power output is then transmitted to the DC power sockets 22 through capacitor means. In FIG. 6, a display circuit 36 is used to indicate the set voltage value. The display circuit 36 is comprised of a microprocessor and a display member (a LCD or a set of LEDs) connected in parallel to the control circuit to indicate the set voltage value. The display circuit 36 may be used with a voltage control, for example, the aforesaid variable resistor VR1 (see the sliding key shown in FIG. 1).

The transforming circuit 31 shown in FIG. 5 is an AC adapter that is connected to one pole of the primary side of the transformer at the rear side of the bridge rectifier, i.e., the transforming circuit comprises a high-frequency voltage-dropping transformer. One pole of the secondary side of the transformer passes through DC current rectification and wave filtration to the other pole of the secondary side of the transformer, and then passes with the other pole of the secondary side of the transformer through DC current limitation and protection, and then passes through photo coupler means and positive feedback circuit means, amplifier and oscillator circuit means to the other pole of the primary side of the transformer, achieving the desired voltage transforming and current rectification operation.

The second protection circuit 38 is comprised of a second switch SW2 and a second fuse FUSE2, forming a part of the DC power socket circuit. As shown in FIG. 1, each DC power socket has a switch VR1 at one side for regulating the voltage, or a power switch SW1 for power on/off control. The first protection circuit 37 is comprised of a first switch SW1 and a first fuse FUSE1. The first switch SW1, as shown in FIG. 1, comprises a light emitting diode LED1 that gives off light upon passing of electricity.

A prototype of extension cable has been constructed with the features of FIGS. 1˜6. The extension cable functions smoothly to provide all of the features discussed earlier.

As indicated above, the simple circuit structure of the present invention has transformer means, rectifier means, filter means, voltage stabilizer means and display means added thereto to provide AC power supply through AC power sockets thereof and DC power supply through DC power sockets thereof. The invention uses chip type transformer means and chip type display means to ensure high performance.

Although particular embodiments of the invention have been described in detail for purposes of illustration, various modifications and enhancements may be made without departing from the spirit and scope of the invention.

What is claimed is:

1. An extension cable comprising an electric plug for city power supply input, an electric outlet assembly, said electric outlet assembly comprising an electrically insulative housing, and a power cable electrically connected between said electric plug and said electric outlet assembly, wherein said electric outlet assembly comprises at least one AC power socket and at least one DC power socket electrically connected in parallel to said power cable, and a control circuit electrically connected between said power cable and said at least one DC power socket, said control circuit comprising a transforming circuit adapted to transform city power supply received from said power cable, a rectifier circuit adapted to rectify AC power supply passing out of said transforming circuit into DC power supply, a filter circuit adapted to remove noises from DC power supply passing out of said rectifier circuit, a voltage stabilizer circuit adapted to stabilize the voltage of DC power supply passing out of said filter circuit, and an output circuit for output of stabilized DC power supply from said voltage stabilizer circuit.

2. The extension cable as claimed in claim 1, wherein said control circuit further comprises a protection circuit comprised of a switch and a fuse.

3. The extension cable as claimed in claim 1, wherein said control circuit further comprises a display circuit, said display circuit being comprised of a microprocessor and a display member.

4. The extension cable as claimed in claim 1, further comprising a voltage selector switch electrically connected between said electric plug and said power cable for selecting input city power supply.

5. The extension cable as claimed in claim 1, wherein said transforming circuit is a transformer.

6. The extension cable as claimed in claim 1, wherein said transforming circuit is an AC adapter.

7. The extension cable as claimed in claim 1, wherein said rectifier circuit is a bridge rectifier.

8. The extension cable as claimed in claim 1, wherein said voltage stabilizer circuit comprises a variable resistor for setting output voltage.

9. The extension cable as claimed in claim 1, further comprising a protection circuit formed of a switch and a fuse and electrically connected between said power cable and said at least one AC power socket.
